(19) United States
(12) Patent Application Publication
(10) Pub. No.: US 2011/0033599 A1
(43) Pub. Date: Feb. 10, 2011

(54) Process For Making An Alcoholic Gelled Food Product

(76) Inventor: Aidan Uttinger, Auckland (NZ)

Correspondence Address: WADDEY & PATTERSON, P.C., 1600 DIVISION STREET, SUITE 500, NASHVILLE, TN, 37203, US

(21) Appl. No.: 12/664,794

(22) PCT Filed: Jun. 16, 2008
(86) PCT No.: PCT/NZ08/00147

§ 371 Date: Sep. 28, 2010

(30) Foreign Application Priority Data
Jun. 15, 2007 (NZ) 555954

(51) Int. Cl. A23L 1/0532; A23L 1/0534

(52) U.S. Cl. 426/575

(57) ABSTRACT

The present invention relates to an alcoholic gelled food product comprising; a gelling agent including at least one carrageenan, a thickening agent comprising sodium carboxyl methyl cellulose (CMC) and ethanol and methods for making such products.

### TECHNICAL FIELD

The present invention relates to a process for making a gelled food product. The present invention also relates to a gelled food product.

### BACKGROUND

Alcoholic products may be provided in liquid or in solid form.

Alcohol has historically been used as a mild relaxant in food and beverage products. The alcohol of choice is ethanol. Ethanol enhances some flavours and improves mouthfeel and also acts as a preservative if used at sufficiently high levels.

However the use of ethanol in the manufacture of alcoholic gelled food products (alcoholic visco-elastic gel food products, e.g. alcoholic jellies for example) has resulted in difficulties. Common food gelling agents such as low methoxyl pectin, high methoxyl pectin, amidated pectin, kappa carrageenan, iota carrageenan, gellan gum and alginate are not usually stable in food systems containing ethanol. The combination of ethanol with such food gelling agents will often result in the formation of an opaque cloud in a final gel, produce high amounts of “syneresis” or a combination of both. Cloudiness and stability problems are known to occur with as little as 4% ethanol.

“Syneresis” describes the process whereby a gel product decomposes through the contraction or denaturation of the gelling agents resulting in a liquid or slurry forming around the gel. The liquid/slurry caused by syneresis has low consumer acceptance. It is therefore desirable to avoid syneresis or jelly breakdown as much as possible.

Attempts to reduce the effect of syneresis have involved the addition of higher levels of gelling and thickening agents. However this can lead to a final product with a hard gel that has an undesirable mouthfeel and is difficult to remove from any single serve portion pack.

Acidic conditions can affect the stability of many gelling agents and result in excessive syneresis of a resulting gelled food product. It may be desirable to add food acids, such as citric acid, or ingredients high in acid, such as lemon juice concentrate, to enhance the flavour of a jelly and increase the effectiveness of most food grade preservatives. However such acids can have a detrimental effect on the stability of the final gel, and can lead to excessive syneresis.

Formulating a gelled food product containing ethanol that is substantially clear, is stable and is easy to remove from the packaging is desirable.

### OBJECT OF THE INVENTION

It is an object of the present invention to provide a process for making a gelled food product which overcomes or ameliorates at least one of the abovementioned disadvantages and/or at least provides the public with a useful choice.

### SUMMARY OF THE INVENTION

According to one aspect of this invention there is provided a method for making a gelled food product, the method including the steps of:
blending dry ingredients including a gelling agent with a thickening agent, wherein the gelling agent includes at least one carrageenan and the thickening agent includes sodium carboxyl methyl cellulose (CMC);
adding the dry ingredients to water to form a mixture; and
adding ethanol to the mixture before allowing it to set into the gelled food product.

Preferably the ethanol is added immediately before allowing the mixture to set.

Preferably the gelling agent includes iota carrageenan.

Preferably the gelling agent includes iota carrageenan in combination with a second gelling agent.

Preferably the second gelling agent is selected from low methoxyl pectin, amidated pectin, kappa carrageenan, furcelleran and alginate.

Preferably the gelling agent includes at least two carrageenans.

Preferably the gelling agent includes a blend of carrageenans.

Preferably the gelling agent and the thickening agent are provided in a proportion in the range of about 10:1 to 2.5:1 by weight, most preferably about 4:1 by weight.

Preferably the blend of carrageenans includes kappa carrageenan and iota carrageenan.

Preferably the mixture is heated before the addition of ethanol.

Preferably the mixture is heated to about 70° C.-85° C. before the addition of ethanol, most preferably the mixture is heated to 80° C.

Preferably the mixture is heated to about 80° C. and then cooled to about 60-66° C. before the addition of ethanol.

Preferably sugar is dry blended with the gelling agent and thickening agent.

Preferably additional sugar is added to the mixture before the addition of ethanol.

Preferably food acid is added to the mixture before the addition of ethanol.

Preferably the food acid may include citric acid, lactic acid, tartaric acid, malic acid, gluconic acid or adipic acid. Most preferably the food acid is adipic acid.

Preferably the ethanol is warmed to about 55° C.-75° C. before addition to the mixture, most preferably the ethanol is warmed to about 65° C.

According to a further aspect of this invention there is provided a gelled food product prepared from the method described above.

According to a further aspect of this invention there is provided a gelled food product including:
a gelling agent and a thickening agent in a proportion in the range of about 10:1 to 2.5:1 by weight;
sugar; and
ethanol;
   wherein the gelling agent includes at least one carrageenan and the thickening agent includes CMC.

Preferably the gelling agent and thickening agent are in a proportion of about 4:1 by weight.

Preferably the at least one carrageenan and the CMC are substantially fully hydrated.

Preferably the gelling agent includes iota carrageenan.

Preferably the gelling agent includes iota carrageenan in combination with a second gelling agent.

Preferably the second gelling agent is selected from low methoxyl pectin, amidated pectin, kappa carrageenan, furcelleran and alginate.

Preferably the gelling agent includes at least two carrageenans.

Preferably the gelling agent includes a blend of carrageenans.

Preferably the gelling agent includes a blend of kappa carrageenan and iota carrageenan.

Preferably the gelled food product includes about 0.1-2% carrageenans and more preferably about 0.2-0.6% carrageenans.

Preferably the blend of carrageenans is provided in proportions between about 1 part kappa carrageenan and 8 parts iota carrageenan to about 1 part kappa carrageenan and 1 part iota carrageenan.

Preferably the gelled food product includes food acids.

Preferably the gelled food product includes citric acid, lactic acid, tartaric acid, malic acid, gluconcic acid or adipic acid, and more preferably adipic acid.

Preferably the gelled food product includes about 0.05%-2.5% food acid, and more preferably about 0.3% food acid.

Preferably the gelled food product includes between about 1-40% sugar, preferably about 15-25% sugar and most preferably about 20% sugar.

Preferably the gelled food product includes about 0.05-0.5% CMC, and more preferably about 0.5-0.1% CMC.

Preferably the gelled food product includes an ethanol content in the ready to consume final product of about 4-25% ethanol, and more preferably about 5-17% ethanol.

Preferably the ethanol is added in the form of vodka.

According to a further aspect of this invention there is provided a gelled food product including:
a gelling agent and a thickening agent;
sugar; and
ethanol;
   wherein the gelling agent includes at least one substantially hydrated carrageenan and the thickening agent includes substantially hydrated CMC.

Preferably the gelling agent includes substantially hydrated iota carrageenan.

Preferably the gelling agent includes substantially hydrated iota carrageenan in combination with a second gelling agent.

Preferably the second gelling agent is substantially hydrated and is selected from low methoxyl pectin, amidated pectin, kappa carrageenan, furcelleran and alginate.

Preferably the gelling agent includes at least two substantially hydrated carrageenans.

Preferably the gelling agent includes a blend of substantially hydrated carrageenans.

Preferably the gelling agent includes a blend of substantially hydrated kappa carrageenan and substantially hydrated iota carrageenan.

According to a further aspect of this invention there is provided a method for making a gelled food product substantially as herein described with reference to any one of the examples.

According to a further aspect of this invention there is provided a gelled food product substantially as herein described with reference to any one of the examples.

### DESCRIPTION OF THE PREFERRED EMBODIMENT

The present invention may be seen as providing a process of making a gelled food product. The eventual product contains a gelling agent, a thickening agent, sugars and ethanol (generally ethanol or a spirit). The ethanol can be provided as a commercially available spirit product such as vodka, whiskey, gin or the like. The product may also include food acids.

Where the term “gelled food product” is used throughout the specification, this should be interpreted as synonymous with the term “visco-elastic gel food product”.

The method of forming the gelled food product includes the steps of (1) blending dry ingredients including a gelling agent with a thickening agent, wherein the gelling agent includes at least one carrageenan and the thickening agent includes sodium carboxyl methyl cellulose (CMC) (2) adding the dry ingredients to water to form a mixture; and (3) adding ethanol to the mixture before allowing it to set into the gelled food product.

Preferably the gelling agent includes iota carrageenan. More preferably, the gelling agent includes iota carrageenan in combination with a second gelling agent. Preferably the second gelling agent is selected from low methoxyl pectin, amidated pectin, kappa carrageenan, furcelleran and alginate. Some of these gelling agents will increase in viscosity when calcium mineral salts are added. However gelling agents that are liquid at higher temperatures but which gel upon cooling are preferred.

Most preferably the gelling agent includes a blend of carrageenans, and the blend includes kappa carrageenan and iota carrageenan.

Preferably the mixture is heated before the addition of ethanol to substantially hydrate the carrageenans and the CMC.

Preferably the first step includes dry blending the dry ingredients with a portion of sugar.

The most preferred blend of carrageenans included in the gelling agent is a combination of kappa carrageenan and iota carrageenan. Kappa carrageenan and iota carrageenan as gelling agents are preferably provided in a ratio of between about 1 part kappa carageenan and 8 parts iota carrageenan to about 1 part kappa carrageenan and 1 part iota carrageenan. Of course it will be appreciated that in some applications of the invention the selection of other carrageenans may be appropriate. For example the selection of an ethanol or a sugar may influence the selection of certain dry ingredients.

The gelling agent and thickening agent are blended together in a proportion of the range of about 10:1 to 2.5:1 by weight, and most preferably about 4:1 by weight. When there is about these proportions in the final product, the inventor has surprisingly found that the level of syneresis is substantially reduced in the resulting gelled food product. Of course in some applications of the present invention the proportions of gelling agent to thickening agent may vary relative to ethanol and/or sugar selection and content.

Sugar is preferably added to the dry blended mixture before it is added to water. Preferably the sugar is sucrose, maltose, dextrose, fructose, lactose and/or glucose syrup or high fructose corn syrup or similar ingredients. The sugar may also include a bulking agent such as polydextrose, maltodextrin, maltitol, lactitol, sorbitol and the like.

The dry ingredients are blended by an apparatus or techniques known to those skilled in the art, such as a ribbon blender.

The blended dry ingredients are added to water and mixed. The mixture is preferably heated to between about 75° C.-85° C., and most preferably 80° C. and held at that temperature for about 2 minutes. The time may vary depending on how long it takes to substantially fully hydrate the dry ingredients in the water. Determining a suitable time and temperature to give appropriate hydration of the dry ingredients would be readily determinable by one of skill in the art once in possession of this invention.

Sufficient water is used to fully hydrate the gelling and thickening agents. The appropriate amount of water would be known to one of skill in the art once in possession of this invention. The gelling agent, preferably a blend combination of kappa carrageenan and iota carrageenan, and the thickening agent, which includes CMC, should be fully hydrated before addition of the ethanol. The inventor has surprisingly found that the gelling and thickening agents may not fully hydrate if heated in the presence of ethanol, which results in a gel that can be opaque, have lower gel strength and has a greater risk of syneresis. Accordingly, the inventors have found that it is important that the ethanol is added after heating the mixture and after substantial hydration of the gelling and thickening agents has taken place.

The combination of adding the gelling agent plus the thickening agent prior to fully hydrating them, or substantially so, before the addition of ethanol appears to overcome many of the problems associated with conventional methods of making alcoholic jellies. Therefore, an aspect of the invention includes heating the aqueous mixture to a temperature and for a time suitable to substantially fully hydrate the gelling and thickening agents before ethanol addition.

Additional sugar and potassium sorbate may be added to the mixture at this stage and mixed while the mixture is held at a temperature of about 80° C. The additional sugar may be the same or different from the form of sugar that has been already added.

Food acid and any other additional ingredients (except ethanol) may be added at this stage. Preferably the food acid is selected from citric acid, malic acid, tartaric acid or adipic acid. Adipic acid is the most preferred option as the product produced when adipic acid is used has been found to be particularly stable.

Additional ingredients added before cooling may include flavouring, colouring, preservative and the like which will be known to those skilled in the art. For example, it may be desirable to include such flavourings including berry, citrus, stonefruit or other fruit flavours or other flavours such as coffee, chocolate flavour etc as would be known to a skilled person. In a further alternative embodiment additional ingredients such as guarana and other botanical extracts may be added by a process as would be known to those skilled in the art.

Once all additional ingredients have been added the mixture is preferably then cooled to about 60-66° C.

The ethanol may be added either as diluted ethanol with water or 30-50% ethanol content or as a spirit. In the preferred embodiment the ethanol is heated to a temperature of 60-66° C. before addition to the mixture. The most preferred ethanol includes Vodka with a 38% ethanol content or other spirits (whiskey, gin etc as would be known to one of skill in the art). However, in an alternative embodiment, wine, fortified wines, or liquours could be added.

The ethanol should be added at the end of the process, after the gelling and thickening agents have been heated in a water mixture to fully hydrate them, and preferably at a temperature which is hot enough to reduce the risk of microbial growth, such as a minimum of about 60° C., and preferably cold enough to reduce evaporation of ethanol during the filling process, such as a maximum of about 70° C. The addition of the ethanol is preferably performed slowly to ensure the temperature of the mix does not fall rapidly. The addition of ethanol as described herein results in a substantially homogeneous gelled food product.

The gelled food product provided by this process is preferably used to fill individual portion pack containers. Preferably this occurs at a temperature of about 35-70° C., which are then sealed and allowed to cool to at least room temperature. The temperature at which the packing occurs is preferably high enough to prevent the risk of microbial growth, and also high enough to reduce the air pressure in the top of the container. Further, it is important to fill the containers at a temperature above their gelling point. If the temperature at which the containers are filled is too low, a broken gel can result, which has an undesirable mouthfeel and significant problems with syneresis.

The containers may be of 10-200 ml capacity in the preferred embodiment and of any dimension to give said amount. The preferred packaging is an oblong cylindrical container of between 3 cm and 12 cm height and of 30-150 ml capacity that is filled at 65° C.±2° C., sealed and allowed to cool until the gelling agents have gelled or set. It will be appreciated that the size and shape of the resulting gelled food product is dictated by the size and shape of the vessel it sets in.

The present invention also includes a gelled food product produced from the process described above. The product is homogeneous and can be formed into any shape depending on the vessel which the product is set in.

According to a further aspect of the invention there is provided a gelled food product including:
a gelling agent and a thickening agent in a proportion in the range of about 10:1 to 2.5:1 by weight;
sugar; and
ethanol;
   wherein the gelling agent includes at least one carrageenan and the thickening agent includes CMC.

Preferably the gelling agent includes a blend of carrageenans and the carrageenans and CMC are substantially fully hydrated.

The inventors believe that syneresis is reduced by making gelled food products by the method of the present invention.

A preferred gelled food product may include:
1. between about 0 and 40% sugar, bulking agent or sugar replacer, preferably between about 15 and 25% sugar and most preferably about 20%;
2. kappa carrageenan and iota carrageenan as gelling agents between about 0.1% and 2% and preferably between about 0.2% and 0.6%;
3. kappa carrageenan and iota carrageenan as gelling agents in a ratio of between about 1 part kappa carageenan and 8 parts iota carrageenan to 1 part kappa carrageenan and I part iota carrageenan;
4. Sodium Carboxyl Methyl Cellulose as a thickening agent at between about 0.05% and 0.5% and preferably at about 0.1%;
5. citric acid, lactic acid, tartaric acid, malic acid, gluconic acid or adipic acid at between about 0.05% and 2.5% and preferably at about 0.3%; and most preferably adipic acid
6. ethanol in a commercially pure form or diluted whereby the final ethanol content of the ready to consume final product contains between about 4% and about 25% ethanol, with an optimal range of about 5 to 17% ethanol.

Alternatively the product may be added to another food product during manufacture. In this case the cooling mixture may be applied directly into the food product ingredients once ethanol is added.

The invention offers several advantages:
1. The resultant gelled food product has an appealing combination of ethanol, sugar, flavour and acid.
2. The resulting gelled food product is substantially stable despite the presence of food acids and ethanol.
3. The final gelled food product is easy to remove from the single serve container.
4. The final gelled product can be manufactured using pure or diluted forms of ethanol.
5. The final gelled product is substantially clear and has minimal syneresis.
6. The final gelled product is microbially stable, is shelf stable and can be distributed at ambient temperature.

The present invention will now be described with reference to the preferred embodiment which is given by way of example only.

### Example 1

The gelled food product has been found to be very effective to produce a batch of strawberry flavoured vodka gel.

| Ingredients | Quantity | |
|---|---|---|
| Sucrose | 200 | kg |
| Kappa Carrageenan (Gelling agent) | 1 | kg |
| Iota Carrageenan (Gelling agent) | 3 | kg |
| Sodium CMC (Thickening agent) | 1 | kg |
| Adipic Acid | 3 | kg |
| Water | 450 | kg |
| Vodka 45° C. | 360 | kg |
| Potassium Sorbate | 0.4 | kg |
| Ponceau 4R colour 5% solution | 0.1 | kg |
| Strawberry Flavour | 1.2 | kg |
| Total | 1029.7 | kg |
| Evaporation and Losses | 29.7 | kg |
| Yield | 1000 | kg |

### Method

1. The kappa carrageenan, iota carrageenan and CMC is dry blended with 20 kg of sugar and slowly added to the 450 kg of water under agitation. The solution is heated to at least about 80° C. and held for about 2 minutes to fully hydrate the gelling and thickening agents.
2. The remaining 180 kg of sugar and potassium sorbate is then added to the mix and allowed to dissolve while maintaining the temperature at 80° C. or above.
3. The 3 kg of adipic acid is added to the mixture. The mixture is then cooled to 65° C.
4. The vodka is either warmed to at least 45° C. and added to the main mix, or the vodka at room temperature is slowly added to the mix while the contents are maintained at 65°. Flavour and colour solution are also added.
5. The composition is then filled into containers, sealed and cooled to ambient temperature to allow the gelling agents to gel.

While in the foregoing description there has been made reference to specific components or integers of the invention having known equivalents then such equivalents are herein incorporated as if individually set forth.

Although this invention has been described by way of example only and with reference to possible embodiments thereof it is to be understood that modifications or improvements may be made without departing from the scope or spirit of the invention.

1. A method for making a gelled food product, the method including the steps of:
blending dry ingredients including a gelling agent with a thickening agent, wherein the gelling agent includes at least one carrageenan and the thickening agent includes sodium carboxyl methyl cellulose (CMC);
adding the dry ingredients to water to form a mixture; and
adding ethanol to the mixture before allowing it to set into the gelled food product.

2. A method according to claim 1 wherein the ethanol is added immediately before allowing the mixture to set.

3. A method according to claim 1 wherein the gelling agent includes iota carrageenan.

4. A method according to claim 1 wherein the gelling agent includes iota carrageenan in combination with a second gelling agent.

5. A method according to claim 4 wherein the second gelling agent is selected from low methoxyl pectin, amidated pectin, kappa carrageenan, furcelleran and alginate.

6. A method according to claim 1 wherein the gelling agent includes at least two carrageenans.

7. A method according to claim 1 wherein the gelling agent includes a blend of carrageenans.

8. A method according to claim 1 wherein the gelling agent and the thickening agent are provided in a proportion in the range of about 10:1 to 2.5:1 by weight.

9. A method according to claim 7 wherein the blend of carrageenans includes kappa carrageenan and iota carrageenan.

10. A method according to claim 1 wherein the mixture is heated before the addition of ethanol.

11. A method according to claim 10 wherein the mixture is heated to about 70° C.-85° C. before the addition of ethanol.

12. A method according to claim 10 wherein the mixture is heated to about 80° C.

13. A method according to claim 12 wherein the mixture is heated to about 80° C. and then cooled to about 60-66° C. before the addition of ethanol.

14. A method according to claim 1 wherein sugar is dry blended with the gelling agent and thickening agent.

15. A method according to claim 14 wherein additional sugar is added to the mixture before the addition of ethanol.

16. A method according to claim 1 wherein food acid is added to the mixture before the addition of ethanol.

17. A method according to claim 16 wherein the food acid may include citric acid, lactic acid, tartaric acid, malic acid, gluconic acid or adipic acid.

18. A method according to claim 17 wherein the food acid is adipic acid.

19. A method according to claim 1 wherein the ethanol is warmed to about 55° C.-75° C. before addition to the mixture.

20. A method according to claim 1 wherein the ethanol is warmed to about 65° C. before addition to the mixture.

21. A gelled food product prepared from the method of claim 1.

22. A gelled food product including:
a gelling agent and a thickening agent in a proportion in the range of about 10:1 to 2.5:1 by weight;
sugar; and
ethanol;
wherein the gelling agent includes at least one carrageenan and the thickening agent includes CMC.

23. A gelled food product according to claim 22 wherein the gelling agent and thickening agent are in a proportion of about 4:1 by weight.

24. A gelled food product according to claim 22 wherein the at least one carrageenan and the CMC are substantially fully hydrated.

25. A gelled food product according claim 22 wherein the gelling agent includes iota carrageenan.

26. A gelled food product according to claim 25 wherein the gelling agent includes iota carrageenan in combination with a second gelling agent.

27. A gelled food product according to claim 26 wherein the second gelling agent is selected from low methoxyl pectin, amidated pectin, kappa carrageenan, furcelleran and alginate.

28. A gelled food product according to claim 22 wherein the gelling agent includes at least two carrageenans.

29. A gelled food product according to claim 22 wherein the gelling agent includes a blend of carrageenans.

30. A gelled food product according to claim 22 wherein the gelling agent includes a blend of kappa carrageenan and iota carrageenan.

31. A gelled food product according to claim 22 wherein the gelled food product includes about 0.1-2% carrageenans and more preferably about 0.2-0.6% carrageenans.

32. A gelled food product according to claim 30 wherein the blend of carrageenans is provided in proportions between about 1 part kappa carrageenan and 8 parts iota carrageenan to about 1 part kappa carrageenan and 1 part iota carrageenan.

33. A gelled food product according to claim 22 wherein the gelled food product includes food acids.

34. A gelled food product according to claim 33 wherein the gelled food product includes citric acid, lactic acid, tartaric acid, malic acid, gluconcic acid or adipic acid.

35. A gelled food product according to claim 34 wherein the gelled food product includes adipic acid.

36. A gelled food product according to claim 33 wherein the gelled food product includes about 0.05%-2.5% food acid.

37. A gelled food product according to claim 33 wherein the gelled food product includes about 0.3% food acid.

38. A gelled food product according to claim 22 wherein the gelled food product includes between about 1-40% sugar.

39. A gelled food product according to claim 22 wherein the gelled food product includes between about 15-25% sugar.

40. A gelled food product according to claim 22 wherein the gelled food product includes about 20% sugar.

41. A gelled food product according to claim 22 wherein the gelled food product includes about 0.05-0.5% CMC.

42. A gelled food product according to claim 22 wherein the gelled food product includes about 0.5-0.1% CMC.

43. A gelled food product according to claim 22 wherein the gelled food product includes an ethanol content in the ready to consume final product of about 4-25% ethanol.

44. A gelled food product according to claim 22 wherein the gelled food product includes an ethanol content in the ready to consume final product of about 5-17% ethanol.

45. A gelled food product according to claim 22 wherein the ethanol is added in the form of vodka.

46. A gelled food product including:
a gelling agent and a thickening agent;
sugar; and
ethanol;
wherein the gelling agent includes at least one substantially hydrated carrageenan and the thickening agent includes substantially hydrated CMC.

47. A gelled food product according to claim 46 wherein the gelling agent includes substantially hydrated iota carrageenan.

48. A gelled food product according to claim 47 wherein the gelling agent includes substantially hydrated iota carrageenan in combination with a second gelling agent.

49. A gelled food product according to claim 48 wherein the second gelling agent is substantially hydrated and is selected from low methoxyl pectin, amidated pectin, kappa carrageenan, furcelleran and alginate.

50. A gelled food product according to claim 46 wherein the gelling agent includes at least two substantially hydrated carrageenans.

51. A gelled food product according to claim 46 wherein the gelling agent includes a blend of substantially hydrated carrageenans.

52. A gelled food product according to claim 51 wherein the gelling agent includes a blend of substantially hydrated kappa carrageenan and substantially hydrated iota carrageenan.

53. (canceled)

54. (canceled)
